(19) United States
(12) Patent Application Publication
(10) Pub. No.: US 2026/0368844 A1
(43) Pub. Date: Nov. 19, 2026

(54) PARALLEL ASYNCHRONOUS GRAPHICS WORKLOADS ON MULTIPLE PROCESSING ENGINES

(71) Applicant: QUALCOMM Incorporated, San Diego, CA (US)

(72) Inventors: Rakshit JOSHI, Almora (IN); Sanjeevi S, Bangalore (IN)

(21) Appl. No.: 19/206,998

(22) Filed: May 13, 2025

(51) Int. Cl. G06T 1/20

(52) U.S. Cl. CPC G06T 1/20

(57) ABSTRACT

Aspects of the disclosure are directed to parallel operations of asynchronous graphics workloads. In accordance with one aspect, the disclosure includes sending a plurality of parsed workload commands for distribution to a plurality of processing engines, wherein the plurality of parsed workload commands includes a plurality of independent commands and a plurality of dependent commands; executing the plurality of independent commands in a first of the plurality of processing engines to generate a plurality of processed independent data packets; executing the plurality of dependent commands in a second of the plurality of processing engines to generate a plurality of processed dependent data packets; and aggregating the plurality of independent data packets and the plurality of dependent data packets to form a consolidated plurality of data packets.

### TECHNICAL FIELD

This disclosure relates generally to the field of information processing systems, and, in particular, to parallel operations of asynchronous graphics workloads on a plurality of processing engines.

### BACKGROUND

An information processing system with a plurality of processing engines and memory devices may operate on a plurality of workloads, depending on the current service demand. A graphics workload with a plurality of graphics tasks is often assigned to a graphics processing unit (GPU). There is a desire to offload some of the plurality of graphics tasks to another processing engine to obtain a faster graphics processing throughput.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides parallel operations of asynchronous graphics workloads. Accordingly, the present disclosure discloses a method including: sending a plurality of parsed workload commands for distribution to a plurality of processing engines, wherein the plurality of parsed workload commands includes a plurality of independent commands and a plurality of dependent commands; executing the plurality of independent commands in a first of the plurality of processing engines to generate a plurality of processed independent data packets; executing the plurality of dependent commands in a second of the plurality of processing engines to generate a plurality of processed dependent data packets; and aggregating the plurality of independent data packets and the plurality of dependent data packets to form a consolidated plurality of data packets.

Another aspect of the disclosure provides an apparatus including: a non-transitory memory configured to store a plurality of parsed workload commands, wherein the plurality of parsed workload commands includes a plurality of independent commands and a plurality of dependent commands; a first processing engine coupled to the non-transitory memory, the first processing engine configured to execute the plurality of independent commands to generate a plurality of processed independent data packets; and a second processing engine coupled to the non-transitory memory, the second processing engine configured to aggregate the plurality of independent data packets and a plurality of dependent data packets to form a consolidated plurality of data packets.

Another aspect of the disclosure provides a non-transitory computer-readable medium storing computer executable code, operable on a device including at least one processor and at least one memory coupled to the at least one processor, wherein the at least one processor is configured to implement parallel operation of asynchronous graphics workloads, the computer executable code including: instructions for causing a computer to send a plurality of parsed workload commands for distribution to a plurality of processing engines, wherein the plurality of parsed workload commands includes a plurality of independent commands and a plurality of dependent commands; instructions for causing the computer to execute the plurality of independent commands in a first of the plurality of processing engines to generate a plurality of processed independent data packets; instructions for causing the computer to execute the plurality of dependent commands in a second of the plurality of processing engines to generate a plurality of processed dependent data packets; and instructions for causing the computer to aggregate the plurality of independent data packets and the plurality of dependent data packets to form a consolidated plurality of data packets.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example graphics processing unit (GPU) pipeline with sequential processing.

FIG. 3 illustrates an example graphics processing unit (GPU) pipeline with two workload types.

FIG. 4 illustrates an example of a parallel graphics processing execution.

FIG. 5 illustrates a first example of a graphics workload execution scheme.

FIG. 6 illustrates a second example of a graphics workload execution scheme.

FIG. 7 illustrates an example flow diagram 700 for implementing parallel operations of asynchronous graphics workloads.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), uses multiple levels of coordination or synchronization. In one example, a slice may include a processing engine (i.e., a subset of the computing system) as well as associated memory units and other peripheral devices. In one example, execution of an application may be decomposed into a workload which is executed by multiple slices or multiple processing engines. A plurality of processor cores may be part of each processing engine where a processor core is an independent processing element which may be operated in parallel with other processor cores. A plurality of processing engines may be aggregated into a processor cluster which shares certain system resources (e.g., cache memory).

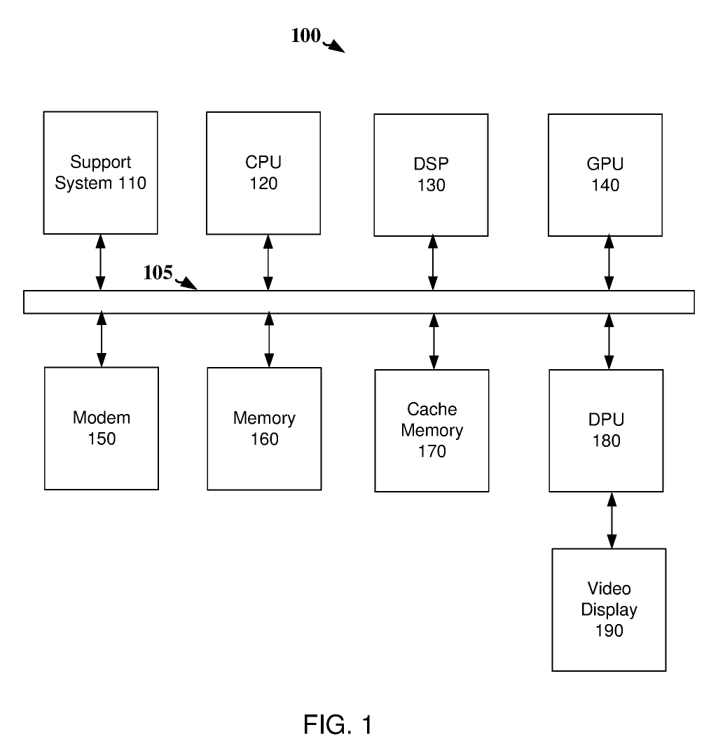

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. In one example, the memories disclosed herein may be non-transitory memory units. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SoC). In one example, the SoC may include the central processing unit (CPU) 120 and other processing engines such as the DSP 130 or the GPU 140. The SoC may also include the memory 160 and the cache memory 170. In one example, the memory 160 is a non-transitory memory.

In one example, the information processing system 100 may be part of a wireless device in a wireless communication system. For example, the wireless communication system may conform to a wireless network protocol such as 4G LTE (long term evolution), 5G NR (new radio), etc.

In one example, the information processing system 100 may also include a neural processing unit (NPU) (not shown). In one example, the NPU is a processing engine optimized for neural processing tasks which involve highly parallel operations such as neural network processing (e.g., convolutional neural network) optimized for speed but allowing lower numerical precision. In one example, offloading certain tasks from the GPU 140 to the NPU may improve overall processing throughput.

In one example, the CPU 120 or the GPU 140 may be configured as an application processor. In one example, the application processor is a processing engine assigned to execute a user application. For example, the user application may be a user algorithm to perform a certain task or generate a desired product for the use.

In one example, certain user applications, such as graphics processing, require intensive computational operations within a defined time constraint. In one example, the defined time constraint is an image frame time (i.e., time allotted for generation of a two-dimensional image frame). In one example, these user applications require high processing throughput. For example, processing throughput is a performance metric which measures a quantity of processing operations per unit time (e.g., floating point operations per second, FLOPS). In one example, the defined time constraint is an image frame time (i.e., time allotted for generation of a two-dimensional image frame). However, in one example, the GPU may be overloaded in its workload which limits an increase in processing throughput.

In one example, a neural processing unit (NPU) is a processing engine optimized for lower-precision, parallel operations. In one example, lower-precision, parallel operations are used in neural network processing (e.g., a convolutional neural network). An example of lower-precision, parallel operations is a plurality of multiply-accumulate operations. In one example, a plurality of graphics processing tasks may operate with a higher processing throughput if some tasks of the plurality of graphics processing tasks are offloaded from the GPU 140 to the NPU. In one example, a user application such as a gaming application with independent clear operations or copy operations (i.e., CC operations) may take advantage of an offloading procedure from the GPU 140 to the NPU for a higher processing throughput.

In one example, the user application may not operate in a parallel manner since it is assigned to be processed sequentially in a GPU pipeline. In one example, a GPU pipeline is a serial processing module in the GPU 140. For example, a user application (e.g., a gaming application) may be executed in one or more GPU pipelines. In one example, a copy operation may operate in parallel if it is offloaded to the NPU prior to the need of the copy operation by the GPU. In one example, usage of parallel offloaded operations may increase the frame rate (in frames per second) of the user application, improve overall user experience and provide a smoother user experience.

In one example, a GPU pipeline may have a GPU workload divided into two task types:
CC workload (e.g., clear/copy operation)
Actual rendering (e.g., draw/dispatch)

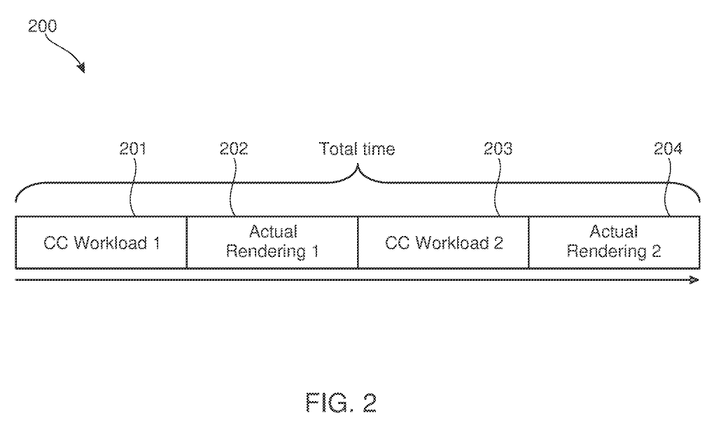

FIG. 2 illustrates an example graphics processing unit (GPU) pipeline 200 with sequential processing. For example, the GPU pipeline 200 includes a first workload 201, followed by a first rendering operation 202, followed by a second workload 203, followed by a second rendering operation 204. In one example, when the GPU workload is submitted to the GPU for execution, it is executed sequentially within the GPU.

In one example, a workload for a user application may be a combination of two workload types. A first workload type may be an independent workload and a second workload type may be a dependent workload. In one example, an independent workload includes independent commands and operations which are not dependent on a previous workload and may be used later in the user application. For example, a clear operation and a copy operation may be independent operations if they are independent of a previous workload. In one example, a dependent workload includes dependent commands and operations which are dependent on a previous workload or which are used in an immediate batch workload. For example, a clear operation and a copy operation may be dependent operations if they are dependent on a previous workload.

In one example, a workload which includes a plurality of independent commands and a plurality of dependent commands may be parsed (i.e., segregated) into a plurality of parsed workload commands. For example, the plurality of parsed workload commands separates the plurality of independent commands from the plurality of dependent commands.

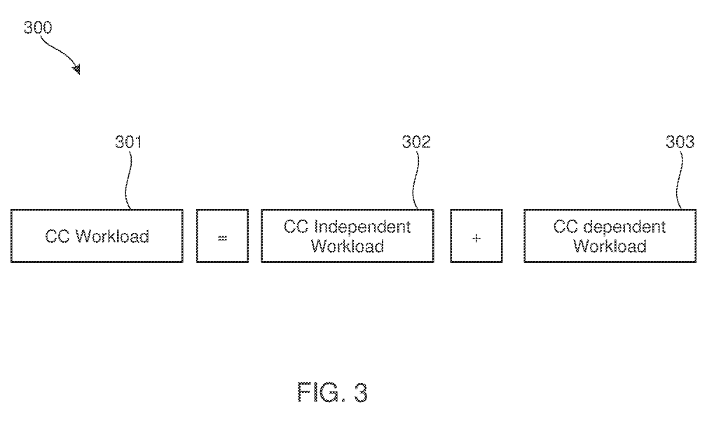

FIG. 3 illustrates an example graphics processing unit (GPU) pipeline 300 with two workload types. In one example, the example GPU pipeline 300 includes a workload 301 which includes an independent workload 302 and a dependent workload 303. In one example, determination of an independent workload with independent commands and a dependent workload with dependent commands may be performed by a user application. In one example, a workload may be tagged (i.e., labeled) as either an independent workload or a dependent workload.

In one example, developers of user applications may not be able to schedule independent workloads to run concurrently due to GPU pipeline limitations, namely, due to a necessity of sequential operations. In one example, offloading independent workloads to a CPU may not be optimal or possible in many scenarios. Consequently, execution of a workload may remain sequential in the GPU, despite the presence of at least one independent workload. In one example, there is need for concurrent GPU and NPU graphics execution to allow improved parallelization.

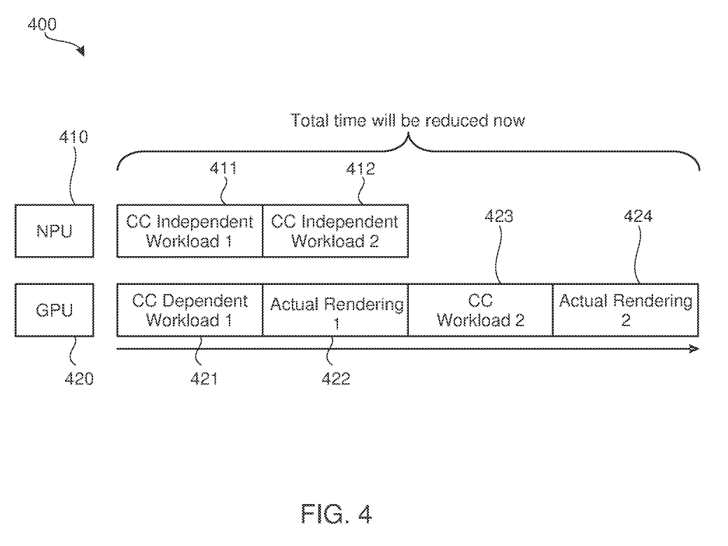

FIG. 4 illustrates an example of a parallel graphics processing execution 400. In one example, the parallel graphics processing execution 400 includes a neural processing unit (NPU) 410 and a graphics processing unit 420. For example, the NPU 410 executes a first independent workload 411 and a second independent workload 412 concurrently while the GPU 420 executes in a first dependent workload 421, a first rendering operation 422, a second dependent workload 423 and a second rendering operation 424.

In one example, parallel graphics processing execution may be performed by exposing an application programming interface (API) to user applications that permits developers to schedule independent workloads (e.g., copy operations, clear operations, etc.) on the NPU instead of the GPU. In one example, parallel execution optimizes performance by offloading certain independent tasks to the NPU to improve efficiency and enhance user experience.

In one example, the API may include independent commands such as:
CopyIndependentResource(source, destination)
ClearIndependentResource(source, destination)

In one example, after a user application sends a plurality of commands and a flush command for execution by the GPU, a user mode driver module (e.g., a graphics driver module) schedules independent commands for the NPU and schedules other commands, including dependent commands, for the GPU. In one example, the user mode driver module maintains synchronization among the plurality of commands. In one example, synchronization means establishing a common time scale and time origin.

In one example, instructions to be executed by the NPU are generated by a user driver or a graphics driver based on a) a resource format, b) GPU-specific internal compression and tiling techniques and c) a format conversion (e.g., for copies), etc.

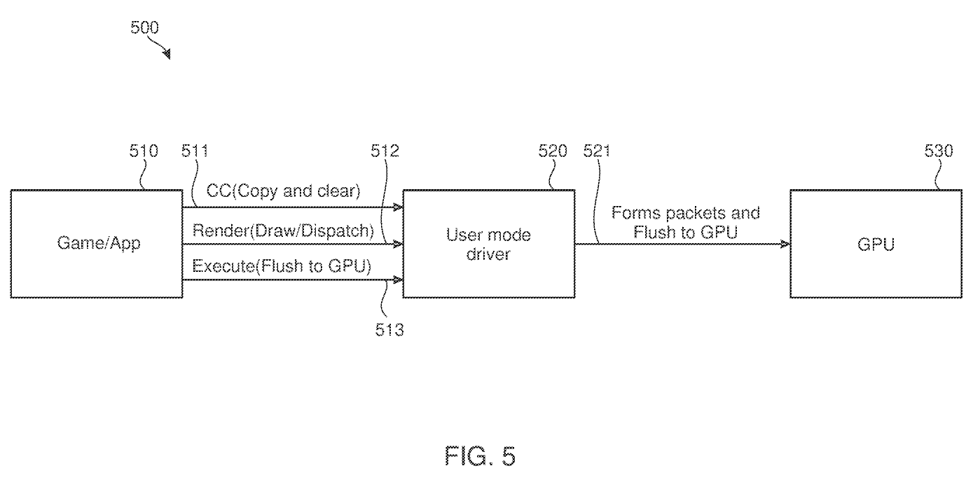

FIG. 5 illustrates a first example of a graphics workload execution scheme 500. In one example, the first graphics workload execution scheme 500 includes a user application (e.g., game) 510, a user mode driver module 520 and a GPU 530. In one example, the first user application 510 sends a clear/copy (CC) directive 511, a render (draw/dispatch) directive 512 and an execute (flush to GPU) directive 513 to the user mode driver module 520. In one example, the user mode driver module 520 sends a plurality of data packets 521 and a flush to GPU directive to the GPU 530.

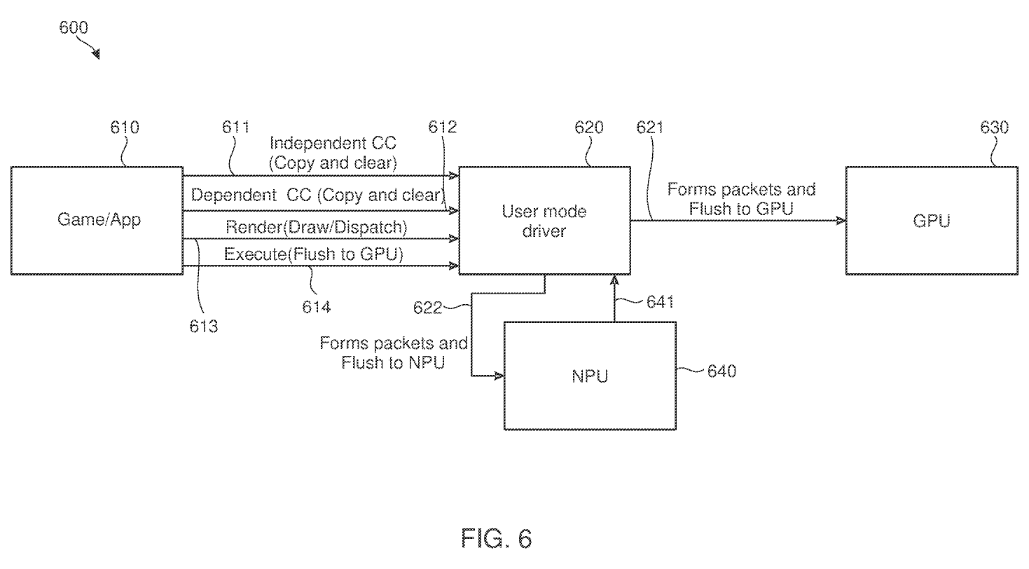

FIG. 6 illustrates a second example of a graphics workload execution scheme 600. In one example, the second graphics workload execution scheme 600 includes a user application (e.g., game) 610, a user mode driver module 620, a GPU 630 and a NPU 640. In one example, the user application 610 sends an independent clear/copy (CC) directive 611, a dependent clear/copy(CC) directive 612, a render (draw/dispatch) directive 613 and an execute (flush to GPU) directive 614 to the user mode driver module 620. In one example, the user mode driver module 620 sends a plurality of data packets 622 and a flush to NPU directive to the NPU 640. In one example, the NPU 640 sends a plurality of processed data packets 641 to the user mode driver 620 which relays the plurality of processed data packets 621 and a flush to GPU directive to the GPU 630.

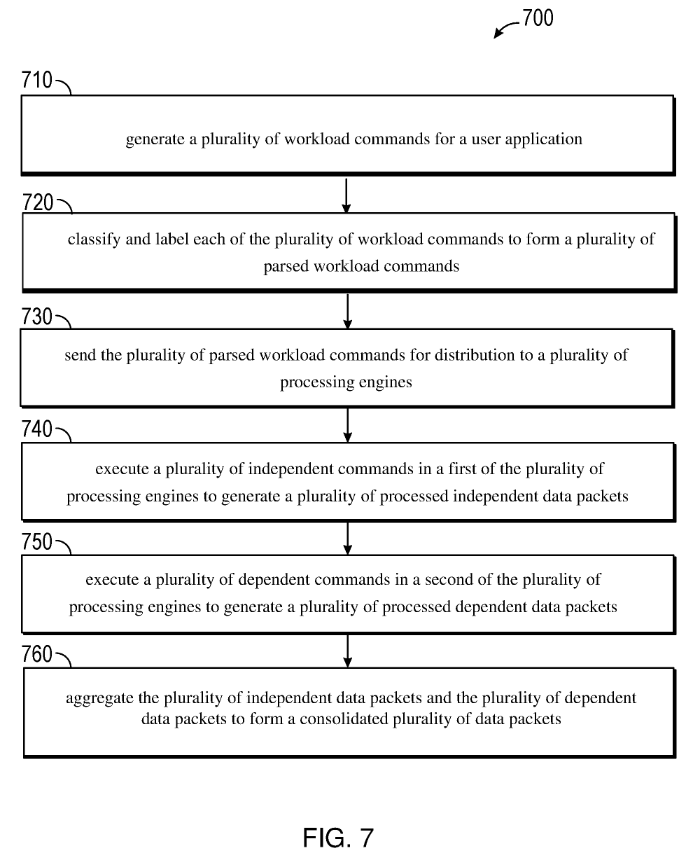

FIG. 7 illustrates an example flow diagram 700 for implementing parallel operations of asynchronous graphics workloads. In block 710, generate a plurality of workload commands for a user application. In one example, a plurality of workload commands for a user application is generated. In one example, the user application is a graphics application. In one example, the plurality of workload commands includes a plurality of independent commands and a plurality of dependent commands. In one example, the generation is performed by an application processor with a user application. In one example, the step of block 710 is performed by one or more of the following: a central processing unit (CPU), a graphics processing unit (GPU), a processing engine, a microprocessor, a computer, a microcontroller, etc.

In block 720, classify and label each of the plurality of workload commands to form a plurality of parsed workload commands. In one example, each of the plurality of workload commands is classified and labeled to form a plurality of parsed workload commands. In one example, the plurality of parsed workload commands separates the plurality of independent commands from the plurality of dependent commands. In one example, the plurality of parsed workload commands includes at least one independent command and at least one dependent command. For example, the label is an appended tag to a workload command. For example, the label is a numerical value which describes the workload command classification.

In one example, an independent command is not dependent on a previous workload command and may be used later in the user application. In one example, a dependent command is dependent on a previous workload command and may be used in an immediate batch workload. In one example, the classification and labeling are performed by the application processor with the user application. In one example, the step of block 720 is performed by one or more of the following: a central processing unit (CPU), a graphics processing unit (GPU), a processing engine, a microprocessor, a computer, a microcontroller, etc.

In block 730, send the plurality of parsed workload commands for distribution to a plurality of processing engines. In one example, the plurality of parsed workload commands is sent for distribution to a plurality of processing engines. In one example, the distribution allows synchronous execution of the plurality of independent commands and the plurality of dependent commands. In one example, synchronous execution establishes a common time scale and time origin for the execution of the plurality of independent commands and the plurality of dependent commands. In one example, the sending of the plurality of parsed workload commands is performed by a user mode driver module. In one example, the step of block 730 is performed by one or more of the following: a generic driver module, a scheduler, a task manager, etc.

In block 740, execute a plurality of independent commands in a first of the plurality of processing engines to generate a plurality of processed independent data packets. In one example, a plurality of independent commands is executed in a first of the plurality of processing engines to generate a plurality of processed independent data packets. In one example, the execution of the plurality of independent commands uses neural network processing. In one example, the plurality of independent commands includes at least one clear command. In one example, the plurality of independent commands includes at least one copy command. In one example, the plurality of independent commands are not dependent on a previous workload.

In one example, the plurality of independent commands is based on a resource format, an internal compression technique, an internal tiling technique, or a format conversion. In one example, the execution of the plurality of independent commands is performed in a neural processing unit (NPU). In one example, the step of block 740 is performed by one or more of the following: a central processing unit (CPU), a graphics processing unit (GPU), a processing engine, a microprocessor, a computer, a microcontroller, etc.

In block 750, execute a plurality of dependent commands in a second of the plurality of processing engines to generate a plurality of processed dependent data packets. In one example, a plurality of dependent commands is executed in a second of the plurality of processing engines to generate a plurality of processed dependent data packets. In one example, the execution of the plurality of dependent commands uses graphical processing. In one example, the plurality of dependent commands includes a plurality of serial commands. In one example, the execution of the plurality of dependent commands is performed in a graphics processing unit (GPU). In one example, the step of block 750 is performed by one or more of the following: a central processing unit (CPU), a graphics processing unit (GPU), a processing engine, a microprocessor, a computer, a microcontroller, etc.

In block 760, aggregate the plurality of independent data packets and the plurality of dependent data packets to form a consolidated plurality of data packets. In one example, the plurality of independent data packets and the plurality of dependent data packets are aggregated to form a consolidated plurality of data packets. In one example, the aggregation maintains a time synchronism among the plurality of independent data packets and the plurality of dependent data packets. In one example, the aggregation is completed within a defined time constraint. In one example, the defined time constraint is an image frame time (i.e., time allotted for generation of a two-dimensional image frame). In one example, the consolidated plurality of data packets represent a single two-dimensional image frame. In one example, the aggregation is performed in the graphics processing unit (GPU). In one example, the step of block 760 is performed by one or more of the following: a central processing unit (CPU), a graphics processing unit (GPU), a processing engine, a microprocessor, a computer, a microcontroller, etc.

The present disclosure discloses, in one example, a method including: sending a plurality of parsed workload commands for distribution to a plurality of processing engines, wherein the plurality of parsed workload commands includes a plurality of independent commands and a plurality of dependent commands; executing the plurality of independent commands in a first of the plurality of processing engines to generate a plurality of processed independent data packets; executing the plurality of dependent commands in a second of the plurality of processing engines to generate a plurality of processed dependent data packets; and aggregating the plurality of independent data packets and the plurality of dependent data packets to form a consolidated plurality of data packets.

In one example, the method further includes maintaining a time synchronism among the plurality of independent data packets and the plurality of dependent data packets. In one example, the method further includes using a neural network processing for the executing the plurality of independent commands.

In one example, the plurality of independent commands includes at least one clear command. In one example, the plurality of independent commands includes at least one copy command. In one example, the plurality of independent commands is based on a resource format, an internal compression technique, an internal tiling technique, or a format conversion.

In one example, the method further includes using a graphical processing for the executing of the plurality of dependent commands. In one example, the plurality of dependent commands includes a plurality of serial commands.

In one example, the method further includes classifying each of a plurality of workload commands; and labeling the each of the plurality of workload commands to form the plurality of parsed workload commands. In one example, the method further includes generating the plurality of workload commands for a user application.

The present disclosure discloses, in one example, an apparatus including: a non-transitory memory configured to store a plurality of parsed workload commands, wherein the plurality of parsed workload commands includes a plurality of independent commands and a plurality of dependent commands; a first processing engine coupled to the non-transitory memory, the first processing engine configured to execute the plurality of independent commands to generate a plurality of processed independent data packets; and a second processing engine coupled to the non-transitory memory, the second processing engine configured to aggregate the plurality of independent data packets and a plurality of dependent data packets to form a consolidated plurality of data packets.

In one example, the first processing engine is a neural processing unit (NPU) and the second processing engine is a graphics processing unit (GPU). In one example, the second processing engine is further configured to execute the plurality of dependent commands to generate the plurality of processed dependent data packets. In one example, the plurality of independent commands includes at least one clear command or at least one copy command.

In one example, the apparatus further includes a user mode driver module coupled to the non-transitory memory, the user mode driver module configured to send the plurality of parsed workload commands for distribution to the first processing engine and the second processing engine. In one example, the distribution allows synchronous execution of the plurality of independent commands and the plurality of dependent commands.

In one example, the apparatus further includes an application processor coupled to the non-transitory memory, the application processor configured to classify and label each of the plurality of workload commands to form the plurality of parsed workload commands. In one example, one of the first processing engine or the second processing engine is further configured to maintain a time synchronism among the plurality of independent data packets and the plurality of dependent data packets.

The present disclosure discloses, in one example, a non-transitory computer-readable medium storing computer executable code, operable on a device including at least one processor and at least one memory coupled to the at least one processor, wherein the at least one processor is configured to implement parallel operation of asynchronous graphics workloads, the computer executable code including: instructions for causing a computer to send a plurality of parsed workload commands for distribution to a plurality of processing engines, wherein the plurality of parsed workload commands includes a plurality of independent commands and a plurality of dependent commands; instructions for causing the computer to execute the plurality of independent commands in a first of the plurality of processing engines to generate a plurality of processed independent data packets; instructions for causing the computer to execute the plurality of dependent commands in a second of the plurality of processing engines to generate a plurality of processed dependent data packets; and instructions for causing the computer to aggregate the plurality of independent data packets and the plurality of dependent data packets to form a consolidated plurality of data packets.

In one example, the non-transitory computer-readable medium further includes: instructions for causing the computer to classify each of a plurality of workload commands; instructions for causing the computer to label the each of the plurality of workload commands to form the plurality of parsed workload commands; and instructions for causing the computer to generate the plurality of workload commands for a user application.

In one aspect, one or more of the steps for providing parallel operations of asynchronous graphics workloads in FIG. 7 may be executed by one or more processors which may include hardware, software, firmware, etc. The one or more processors, for example, may be used to execute software or firmware needed to perform the steps in the flow diagram of FIG. 7. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
sending a plurality of parsed workload commands for distribution to a plurality of processing engines, wherein the plurality of parsed workload commands includes a plurality of independent commands and a plurality of dependent commands;
executing the plurality of independent commands in a first of the plurality of processing engines to generate a plurality of processed independent data packets;
executing the plurality of dependent commands in a second of the plurality of processing engines to generate a plurality of processed dependent data packets; and
aggregating the plurality of independent data packets and the plurality of dependent data packets to form a consolidated plurality of data packets.

2. The method of claim 1, further comprising maintaining a time synchronism among the plurality of independent data packets and the plurality of dependent data packets.

3. The method of claim 1, further comprising using a neural network processing for the executing the plurality of independent commands.

4. The method of claim 3, wherein the plurality of independent commands includes at least one clear command.

5. The method of claim 3, wherein the plurality of independent commands includes at least one copy command.

6. The method of claim 3, wherein the plurality of independent commands is based on a resource format, an internal compression technique, an internal tiling technique, or a format conversion.

7. The method of claim 3, further comprising using a graphical processing for the executing of the plurality of dependent commands.

8. The method of claim 7, wherein the plurality of dependent commands includes a plurality of serial commands.

9. The method of claim 7, further comprising:
classifying each of a plurality of workload commands; and
labeling the each of the plurality of workload commands to form the plurality of parsed workload commands.

10. The method of claim 9, further comprising generating the plurality of workload commands for a user application.

11. An apparatus comprising:
a non-transitory memory configured to store a plurality of parsed workload commands, wherein the plurality of parsed workload commands includes a plurality of independent commands and a plurality of dependent commands;
a first processing engine coupled to the non-transitory memory, the first processing engine configured to execute the plurality of independent commands to generate a plurality of processed independent data packets; and
a second processing engine coupled to the non-transitory memory, the second processing engine configured to aggregate the plurality of independent data packets and a plurality of dependent data packets to form a consolidated plurality of data packets.

12. The apparatus of claim 11, wherein the first processing engine is a neural processing unit (NPU) and the second processing engine is a graphics processing unit (GPU).

13. The apparatus of claim 12, wherein the second processing engine is further configured to execute the plurality of dependent commands to generate the plurality of processed dependent data packets.

14. The apparatus of claim 13, wherein the plurality of independent commands includes at least one clear command or at least one copy command.

15. The apparatus of claim 13, further comprising a user mode driver module coupled to the non-transitory memory, the user mode driver module configured to send the plurality of parsed workload commands for distribution to the first processing engine and the second processing engine.

16. The apparatus of claim 15, wherein the distribution allows synchronous execution of the plurality of independent commands and the plurality of dependent commands.

17. The apparatus of claim 15, further comprising an application processor coupled to the non-transitory memory, the application processor configured to classify and label each of the plurality of workload commands to form the plurality of parsed workload commands.

18. The apparatus of claim 17, wherein one of the first processing engine or the second processing engine is further configured to maintain a time synchronism among the plurality of independent data packets and the plurality of dependent data packets.

19. A non-transitory computer-readable medium storing computer executable code, operable on a device comprising at least one processor and at least one memory coupled to the at least one processor, wherein the at least one processor is configured to implement parallel operation of asynchronous graphics workloads, the computer executable code comprising:
instructions for causing a computer to send a plurality of parsed workload commands for distribution to a plurality of processing engines, wherein the plurality of parsed workload commands includes a plurality of independent commands and a plurality of dependent commands;
instructions for causing the computer to execute the plurality of independent commands in a first of the plurality of processing engines to generate a plurality of processed independent data packets;
instructions for causing the computer to execute the plurality of dependent commands in a second of the plurality of processing engines to generate a plurality of processed dependent data packets; and
instructions for causing the computer to aggregate the plurality of independent data packets and the plurality of dependent data packets to form a consolidated plurality of data packets.

20. The non-transitory computer-readable medium of claim 19, further comprising:
instructions for causing the computer to classify each of a plurality of workload commands;
instructions for causing the computer to label the each of the plurality of workload commands to form the plurality of parsed workload commands; and
instructions for causing the computer to generate the plurality of workload commands for a user application.
